(19) United States
(12) Patent Application Publication
(10) Pub. No.: US 2013/0293629 A1
(43) Pub. Date: Nov. 7, 2013

(54) IMAGE FORMING APPARATUS USING A PRE-PROCESSING LIQUID AND A POST-PROCESSING LIQUID, AND IMAGE FORMING METHOD USING A PRE-PROCESSING LIQUID AND A POST-PROCESSING LIQUID

(71) Applicants: Yukihito NIINO, Kawasaki (JP); Yoshinari SUZUKI, Atsugishi (JP); Kazuki Yasu, Sagamiharashi (JP)

(72) Inventors: Yukihito NIINO, Kawasaki (JP); Yoshinari SUZUKI, Atsugishi (JP); Kazuki Yasu, Sagamiharashi (JP)

(21) Appl. No.: 13/874,849

(22) Filed: May 1, 2013

(30) Foreign Application Priority Data
May 1, 2012 (JP) 2012-104794
Apr. 25, 2013 (JP) 2013-092705

(51) Int. Cl. B41J 2/01

(52) U.S. Cl. CPC B41J 2/01
USPC 347/21

(57) ABSTRACT

An image forming apparatus including an image forming unit that ejects droplets on a image forming apparatus, and forms an image on a surface of the printing medium; a pre-processing unit that applies a pre-processing liquid to the surface of the printing medium before forming the image by the image forming unit; and a post-processing unit that applies a post-processing liquid, that is different from the pre-processing liquid, to the surface of the printing medium after the forming of the image by the image forming unit, wherein the pre-processing unit applies an amount of the pre-processing liquid which is determined based on resolution of the formed image on the printing medium, the post-processing unit applies on amount of the post-processing liquid which is determined based on the resolution of the formed image on the printing medium.

### CROSS REFERENCE TO RELATED APPLICATIONS

The present application claims priority to Japanese Patent Application 2013-092705, filed on Apr. 25, 2013, which claims priority to Japanese Patent Application 2012-104794, filed on May 1, 2012, the entire contents of both are incorporated herein by reference.

### BACKGROUND OF THE INVENTION

1. Field of the Invention

Embodiments of the present invention relate to an image forming apparatus, and an image forming method.

2. Description of the Related Art

An inkjet image forming method has rapidly been adopted in recent years owing to an advantageous property that the method is easily enhanced for a method of forming color images, as well as properties that the method is noiseless and has a low running cost.

JP-A No. H10-226055 discloses an art of a preliminary process for ejecting an ink after ejecting a processing liquid on a printing medium and a post-process for ejecting the processing liquid after ejecting the ink on the printing medium.

With the technology disclosed in the above-described document, the processing liquid makes the coloring agent in the ink insoluble or coagulated. When the printing medium on which an image is formed by the ink is scraped against an object (e.g., the other printing medium), a part of the image is occasionally peeled off.

### SUMMARY OF THE INVENTION

The embodiments of the present invention have been developed in view of the above-described problems of the conventional techniques.

An objective of the embodiments of the present invention is to provide an image forming apparatus and an image formation method that can improve the abrasion resistance of the printing medium on which the image is formed.

In one aspect, there is provided an image forming apparatus including an image forming unit configured to eject the droplets on a image forming apparatus, and to form an image on a surface of the printing medium; a pre-processing unit configured to apply a pre-processing liquid to the surface of the printing medium before forming the image by the image forming unit; and a post-processing unit configured to apply a post-processing liquid different from the pre-processing liquid to the surface of the printing medium after forming the image by the image forming unit, wherein the pre-processing unit applies on amount of the pre-processing liquid which is determined based on resolution of the image forming on the printing medium, the post-processing unit applies on amount of the post-processing liquid which is determined based on resolution of the image forming on the printing medium.

In another aspect, there is provided an image forming method including the steps of applying the pre-processing liquid to a surface of a printing medium; forming an image to the surface of the printing medium on which pre-processing liquid is applied; and applying the post-processing liquid different from the pre-processing liquid to the surface of the printing medium on which the image is formed, wherein the pre-processing liquid is applied on amount of the pre-processing liquid which is determined based on resolution of the image forming on the printing medium, the post-processing liquid is applied on amount of the post-processing liquid which is determined based on resolution of the image forming on the printing medium.

According to the embodiments of the present invention, the image forming apparatus and the image formation method are provided in order to improve the abrasion resistance of the printing medium on which the image is formed.

### BRIEF DESCRIPTION OF THE DRAWINGS

A more complete appreciation of the invention and many of the attendant advantages will be readily obtained as the same becomes better understood by reference to the following detailed description when considered in connection with the accompanying drawings, wherein:

FIG. 1 is a schematic side view showing an example of the image forming apparatus according to an embodiment of the present invention;

FIG. 2 is a schematic configuration view showing an example of a pre-processing unit of the image forming apparatus according to an embodiment of the present invention;

FIG. 3 is a schematic configuration view showing an example of a drying unit of the image forming apparatus according to an embodiment of the present invention;

FIG. 4 is a schematic plan view showing an example of a image forming unit and a post-processing unit of the image forming apparatus according to an embodiment of the present invention;

FIG. 5 is a schematic plan view showing an example of a head unit of a ejecting head for ejecting the black color ink of the image forming unit according to an embodiment of the present invention;

FIG. 6 is a cross sectional view showing an example of a cross section shown along a longitudinal direction of a liquid chamber according to an embodiment of the present invention;

FIG. 7 is a cross sectional view showing an example of a cross section shown along a lateral direction of the liquid chamber according to an embodiment of the present invention;

FIG. 8 is an illustration showing an example of the printing medium on which the image is formed by the image forming apparatus according to an embodiment of the present invention;

FIG. 9 is a schematic configuration view showing an example of a controlling unit of the image forming apparatus according to an embodiment of the present invention;

FIG. 10 is a schematic configuration view showing an example of a superordinate apparatus of the controlling unit according to an embodiment of the present invention;

FIG. 11 is a functional block diagram showing an example of functions of the controlling unit according to an embodiment of the present invention;

FIG. 12 is a functional block diagram showing an example of functions of a data management unit in the controlling unit according to an embodiment of the present invention;

FIG. 13 is a functional block diagram showing an example of functions of an image output unit in the controlling unit according to an embodiment of the present invention;

FIG. 14 is a flowchart showing an exemplary operation by the image forming apparatus according to an embodiment of the present invention;

FIG. 15 is an illustration showing the relationship between the granularity of an image and the coating amount of pre-processing liquid according to an embodiment of the present invention; and

FIG. 16 is a flowchart showing an exemplary operation by the image forming apparatus according to an embodiment of the present invention.

### DETAILED DESCRIPTION OF THE PREFERRED EMBODIMENTS

Referring now to the drawings, wherein like reference numerals designate identical or corresponding parts throughout the several views.

Hereinafter, an embodiment of the present invention will be explained by describing the inkjet image forming apparatus. This invention can be also applied to any image forming apparatus having a ejecting unit (ejecting head, ink head, recording head, or the like) that forms (prints or the like) an image on a printing medium by ejecting recording liquid droplets (ink or the like) such as a facsimile device, a copier device, a multi-function peripheral, or the like, otherwise than as specifically described herein. An embodiment of the present invention will be explained in the following order.
1. A configuration of an image forming apparatus.
2. A configuration of a sheet feeding unit.
3. A configuration of a pre-processing unit.
4. A configuration of a drying unit.
5. A configuration of an image forming unit.
6. A configuration of a post-processing unit.
7. A configuration of a sheet discharging unit.
8. A configuration of a controlling unit.
9. A first example of the operations of the inkjet image forming apparatus.
10. A second example of the operations of the inkjet image forming apparatus (an example that the adjustment of the amount of post-processing liquid is added to the first example).

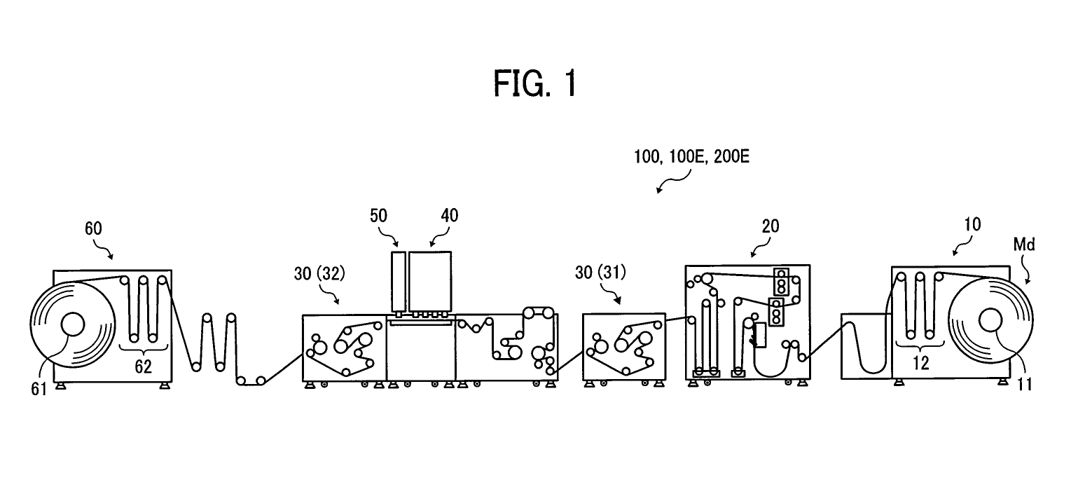

A configuration of an image forming apparatus will now be discussed. The outline of an image forming apparatus 100 according to an embodiment of the present invention is explained with reference to FIGS. 1 to 5.

Although the present invention has been described using an image forming apparatus having ejecting heads (recording head, print heads, ink heads) of the four colors of black(K), cyan(C), magenta(M), and yellow(Y), the scope of the present invention is not limited to the described image forming apparatus having these ejecting heads. The scope of the present invention includes the image forming apparatus also having the ejecting heads of green (G) red (R), light cyan (LC), and/or other colors, and the image forming apparatus only having a ejecting head of black (K). In the following explanation, Y, C, M, and K represent colors of yellow, cyan, magenta, and black, respectively.

Although the present invention has been described using a continuous form sheet in the form of a roll (hereinafter referred to as “roll sheet Md”) as the printing medium, the printing medium that can be formed by the printing apparatus of the present invention is not limited to the roll sheet. The printing medium that can be formed by the printing apparatus of the present invention may also be a cut sheet. The scope of the printing medium that can be formed by the printing apparatus of the present invention includes the medium upon which can be formed an image by the liquid droplets on the surface such as standard paper, high quality paper, thick paper, thin paper, cut sheet, roll sheet, a OHP sheet, synthetic resin film, and metal thin film. The continuous form sheet includes perforated box paper or unperforated roll paper. A page of the box paper is for example between a perforation and the next perforation.

As shown in FIG. 1, an image forming apparatus 100 according to an embodiment includes a sheet feeding unit 10 that feeds the roll sheet Md (printing medium), a pre-processing unit 20 that applies a pre-processing treatment to the roll sheet Md which is fed by the sheet feeding unit 10, and a drying unit 30 that dries the roll sheet Md which was treated by the pre-processing unit 20. Furthermore, the image forming apparatus 100 includes an image forming unit 40 that forms an image on a surface of the roll sheet Md, a post-processing unit 50 that applies a post-processing treatment to the roll sheet Md on which is formed an image by the image forming unit 40, and a sheet discharging unit 60 that discharges the roll sheet Md which was treated by the post-processing unit 50.

The image forming apparatus 100 according to an embodiment of the invention feeds the roll sheet Md by the sheet feeding unit 10, applies a pre-processing treatment to the surface of the roll sheet Md by the pre-processing unit 20, and dries the surface of the roll sheet Md by the drying unit 30. The image forming apparatus 100 forms an image, using the image forming unit 40, on the surface of the roll sheet Md which treated the pre-processing treatment and has dried. Furthermore, the image forming apparatus 100 applies the post-processing treatment, using the post-processing unit 50, to the roll sheet Md on which an image is formed. Then, the image forming apparatus 100 rolls up (discharges) the roll sheet Md by using the sheet discharging unit 60.

Hereinafter, each component of the image forming apparatus 100 according to the present invention will be described in more detail. The image forming apparatus 100 controls the pre-processing unit 20, the drying unit 30 (a pre-processing liquid drying unit 31, or a post-processing liquid drying unit 32) or post-processing unit 50 based on the resolution of an image to be printed. It is possible that the image forming apparatus 100 does not include the drying unit 30 or the like.

A configuration of the sheet feeding unit will now be described. The sheet feeding unit 10 is a unit that feeds a printing medium to the pre-processing unit 20. In this embodiment, the sheet feeding unit 10 includes a sheet holder 11, and plural conveyance rollers 12. The sheet feeding unit 10 conveys a roll sheet Md which is held by the sheet holder 11 to the pre-processing unit 20 by the conveyance rollers 12.

A configuration of the pre-processing unit will now be described. The pre-processing unit 20 is a unit that treats a printing medium before the image processing unit 40 will form an image on the printing medium. In this embodiment, the pre-processing unit 20 treats a surface of the roll sheet Md which is conveyed by the feeding unit 10. The pre-processing unit 20 treats the surface with a pre-processing liquid.

Pre-processing is a process of uniformly applying the pre-processing liquid to a surface of the roll sheet Md (printing mediums). The pre-processing liquid has a function of aggregating a droplet of ink.

The pre-processing unit 20 of the image forming apparatus 100 according to the present invention can control the amount of the pre-processing liquid applied to the roll sheet Md based on the resolution (dot per inch) of an image to be printed. This enables the image forming apparatus 100 to apply a pre-processing liquid which has a function of aggregating a droplet of ink to a surface of the printing medium before the image processing unit 40 will form an image on the printing medium, in case that the image forming apparatus 100 forms an image on a different printing medium from a sheet for inkjet. This enables the image forming apparatus 100 to reduce problems such as bleeding of the image, problems with image density, problems with image tone, a problem with ink strike-through, problems with water resistance, or problems with resistance of the environment. That is, the image forming apparatus 100 can improve the quality of an image which is formed on the printing medium, by applying the pre-processing liquid which has a function of aggregating a droplet of ink to the printing medium by the pre-processing unit 20 before the image forming unit 40 will form the image on the printing medium.

Additionally, the image forming apparatus 100 may apply the pre-processing liquid which has a function of aggregating a droplet of ink to the sheet for inkjet by the pre-processing unit 20, before the image forming unit 40 will form the image on the sheet for inkjet.

The pre-processing method by the pre-processing unit 20 according to an embodiment is not restricted and can be selected appropriately according to the object, and examples of the method for applying the pre-processing liquid include a blade coating method, a gravure coating method, a gravure offset coating method, a bar coating method, a roll coating method, a knife coating method, an air knife coating method, a comma coating method, a U-comma coating method, an AKKU coating method, a smoothing coating method, a micro gravure coating method, a reverse roll coating method, a 4-roll or 5-roll coating method, a dip coating method, a curtain coating method, a slide coating method and a die coating method.

The pre-processing unit 20 according to an embodiment can use a treating liquid which includes water soluble aliphatic amino acids as the pre-processing liquid. The treating liquid which includes water soluble aliphatic amino acids has a behavior of aggregating a water-dispersible colorant. The aggregating means converges each of the water-dispersible colorant particles.

Furthermore, the pre-processing unit 20 can adsorb ions onto the surface of the water-dispersible colorant by adding an ionic object such as water soluble aliphatic amino acids in the pre-processing liquid. This enables the pre-processing unit 20 to neutralize the surface charge of the water-dispersible colorant. This also enables the pre-processing unit 20 to aggregate more of the water-dispersible colorant by increasing the aggregate by the force between the molecules.

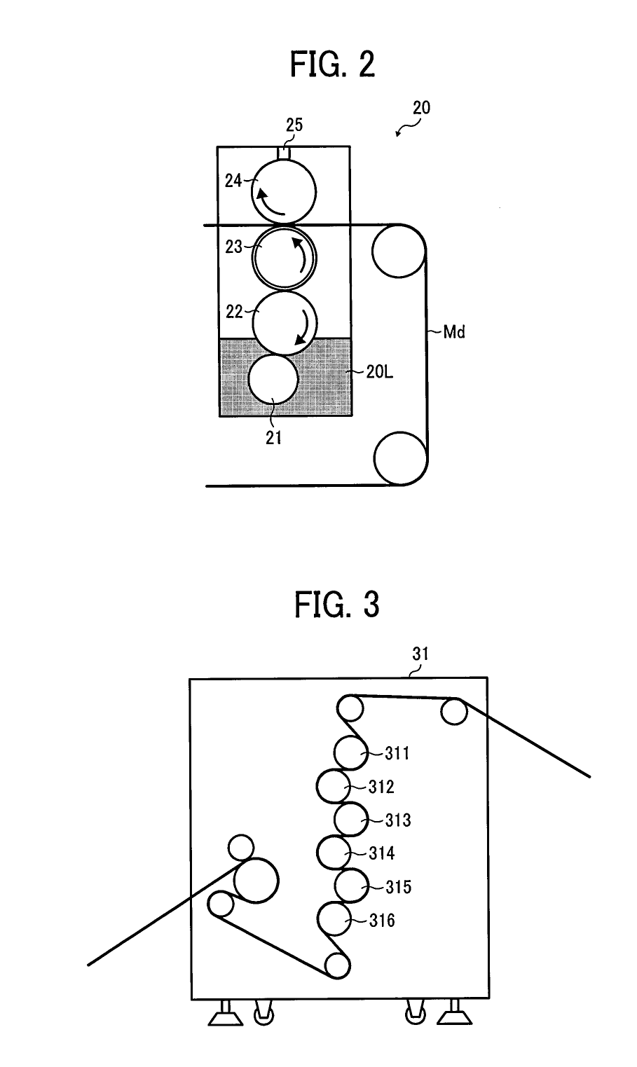

An embodiment of a pre-processing unit 20 using a roll coating method will be described with reference to FIG. 2.

As shown in FIG. 2, the pre-processing unit applies a pre-processing liquid 20L which is stored in the pre-processing unit 20 to a surface of the roll sheet Md which is conveyed (fed) to the pre-processing unit 20 by the feeding unit 10 (FIG. 1).

Specifically, a stirring roller 21 and a transferring roller 22 form the pre-processing liquid 20L as a thin film to a surface of an applying roller first. Next, the pre-processing unit 20 presses the applying roller 23 against a platen roller 24, and rotates the applying roller 23. In this state, the pre-processing unit 20 conveys the roll sheet Md between the applying roller 23 and the platen roller 24. This enables a surface of the roll sheet Md to be applied with the pre-processing liquid 20L.

A pressure controller 25 of the pre-processing unit 20 controls the nip pressure between the applying roller 23 and the platen roller 24 during the time that the pre-processing unit applies the pre-processing liquid 20L. The nip pressure is a force acting on a position of contact between the applying roller 23 and the platen roller 24. The pre-processing unit 20 can control (change) the amount of the pre-processing liquid applied to the roll sheet Md by controlling (changing) the nip pressure by the pressure controller 25. The amount of applied pre-processing liquid is based on the amount of liquid, the amount of time applied, the amount of liquid after drying, and the thickness of the liquid film.

Furthermore, the pre-processing unit 20 controls the rotation speed of the applying roller 23 and the platen roller 24. The pre-processing unit can control (change) the amount of the pre-processing liquid applied by controlling (changing) the rotation speed of the applying roller 23 and the platen roller 24. Additionally, the pre-processing unit 20 may control the applying unit 23 and/or the platen roller by controlling the power source (motor or the like) driving the applying unit 23 and/or the platen roller 24.

Accordingly, the pre-processing unit 20 of the image forming apparatus according to an embodiment of present invention using the roll coating method can more uniformly apply the liquid to a surface of the roll sheet Md (printing medium) than using the spray coating method. The pre-processing unit 20 of this embodiment can uniformly and thinly apply the pre-processing liquid 20L to a surface of the roll sheet Md when the pre-processing liquid 20L has a high viscosity. The pre-processing unit 20 enables the image which will form after the pre-processing method to have reduced image bleeding by uniformly and thinly applying the pre-processing liquid 20L to the roll sheet Md. This enables improvement in the image quality.

The pre-processing unit 20 of the image forming apparatus according to this embodiment can apply the amount of the pre-processing liquid 20L suitable for the image forming method and post-processing method to the roll sheet Md (printing medium) by controlling the amount of the pre-processing liquid by controlling the applying roller 23 and/or the platen roller 24.

Furthermore, the pre-processing unit 20 of the image forming apparatus according to this embodiment can control the amount of applying of the pre-processing liquid 20L based on the type of the printing medium by controlling the amount of the pre-processing liquid by controlling the applying roller and/or the platen roller 24. The pre-processing unit 20 of the image forming apparatus 100 according to this embodiment can improve the image quality because the pre-processing unit 20 can control the amount of the applied pre-processing liquid 20L.

A configuration of the drying unit will now be described. The drying unit 30 is the unit used to dry the printing medium by heating or the like. As shown in FIG. 1, the drying unit 30 in this embodiment includes the pre-processing liquid drying unit 31 which dry the roll sheet Md which was treated by the pre-processing unit 20, and the post-processing liquid drying unit 32 which dries the roll sheet Md which was treated by the post-processing unit 50. The drying unit 30 of the image forming apparatus 100 according to this embodiment can control the drying strength of the pre-processing liquid drying unit 31 and/or the drying strength of the post-processing liquid drying unit 32 based on the resolution (dot per inch) of an image to be printed. A configuration of the pre-processing liquid drying unit 31 will be described with reference to FIG. 3.

As shown in FIG. 3, the pre-processing liquid drying unit 31 of this embodiment uses plural heating rollers 311 to 316 for increasing the drying effect. The pre-processing liquid drying unit 31 controls (changes) the drying strength based on the resolution of an image to be printed. Furthermore, the pre-processing liquid drying unit 31 also can control the drying strength based on the amount of applying of the pre-processing liquid 20L per unit area.

Specifically, the heating roller 311 (or 312 or the like) is heated from 40 degree C. to 80 degrees C., and a surface of the roll sheet Md in which the pre-processing liquid 20L was applied contacts the heating roller 311 (or 312, or the like). This enables the pre-processing liquid drying unit 31 to dry the roll sheet Md (the pre-processing liquid on the roll sheet Md) by evaporating the water in the pre-processing liquid by heating the surface of the roll sheet Md by the heating roller 311 (or 312, or the like)

The pre-processing liquid drying unit 31 lowers the temperature of the heating roller 311 (312, etc), when the pre-processing liquid drying unit 31 lowers the dry strength. For example, the pre-processing liquid drying unit 31 lowers the temperature when using the ink which has a low penetrability, and raises the temperature when using ink which has a high penetrability. The pre-processing liquid drying unit heats the heating unit 311 (or 312 or the like) from 40 degrees C. to 80 degrees C., for example.

Furthermore, the pre-processing liquid drying unit 31 may control the dry strength by controlling the number of heating rollers which are used, in such a manner that the heating roller 311 and the heating roller 312 are heated, and the other heating rollers are not heated. Additionally, the pre-processing liquid drying unit 31 can control the drying strength by controlling both the temperature of the heating rollers and the number of rollers which are used, and can control the drying strength by only controlling the temperature of the heating rollers or the number of the heating rollers which are used.

A description of the configuration of the post-processing liquid drying unit 32 will be omitted because it is basically the same as the pre-processing liquid drying unit 31. Additionally, the post-processing liquid drying unit 32 can control the drying strength based on the resolution of an image to be printed. Furthermore, the post-processing liquid drying unit 32 also can control the drying strength based on the amount of the post-processing liquid 50L per unit area applied by the post processing unit 50. The post-processing liquid drying unit 32 lowers the temperature when using ink which has a low penetrability, and raises the temperature when using ink which has a high penetrability.

Accordingly, the drying unit 30 (the pre-processing liquid drying unit 31 and the post-processing liquid drying unit 32) can control the drying strength by controlling the temperature of the heating rollers and/or the number of the heating rollers which are used. The drying unit 30 of the image forming apparatus 100 according to this embodiment can optimize the drying strength for the printing medium based on the resolution of an image to be printed, because the drying unit 30 can control the drying strength. Furthermore, the drying unit 30 of the image processing unit 100 according to this embodiment can prevent the contraction of the printing medium by preventing excessive drying of the pre-processing liquid, and can prevent the degrading of quality of the image by preventing the dry shortage of the pre-processing liquid, because of controlling the drying strength of the pre-processing liquid drying unit 31 based on the resolution of an image to be printed. That is, the image forming apparatus 100 according to this embodiment can improve the image quality (printing quality).

The drying unit 30 of the image forming apparatus 100 according to this embodiment can improve the image quality by preventing the degrading of the scratch resistance properties of the image, by preventing a shortage of dried post-processing liquid, and by controlling the drying strength of the post-processing liquid drying unit 32 based on the resolution of an image to be printed. Furthermore the drying unit 30 of the image forming apparatus according to this embodiment can prevent the contraction of the printing medium by preventing it from becoming too dry, due to controlling the drying strength of the post-processing liquid drying unit 32 based on the resolution of an image to be printed.

The ink may include an additive such as glycerin for keeping the physical property value such as viscosity and surface tension of the ink, in order that inkjet image forming apparatus may eject ink droplets in the same condition. When the prepared ink is used, the penetrability of the ink and glossiness of the image to be printed is different according to the resolution of an image to be printed. The drying unit 30 of the image forming apparatus 100 according to this embodiment can dry the pre-processing liquid or post processing liquid optimally for the ink, when the image forming unit 40 uses the low penetrability ink. This enables the drying unit 30 according to this embodiment to prevent occurring problems such as the degrading of the image quality due to the dry shortage of the pre-processing liquid, and peeling off of part of the image on the printing medium due to scrapping against an object (e.g., the other printing medium) before drying the post-processing liquid. The drying unit 30 according to this embodiment can improve the image quality (printing quality) by preventing the contraction of the printing medium due to over dryness, when the image forming unit 40 uses high penetrability ink.

The drying unit 30 according to present invention is not limited to include the heating roller as a drying method. That is, the drying unit 30 can use any drying method such as an infrared ray drying method, a microwave drying method, or a hot-air drying method. The drying unit 30 can use a plurality of methods in combination. Furthermore, the drying unit 30 can heat (pre-heat) the roll sheet Md (printing medium) before the pre-processing unit 20 applies the pre-processing liquid.

A configuration of the image forming unit will be described next.

The image forming unit 40 is the unit for forming an image onto a printing medium. The image forming unit 40 of this embodiment forms an image on a surface of the roll sheet Md by ejecting the recording liquid droplets (ink or the like) on the roll sheet Md which was dried by the drying unit 30.

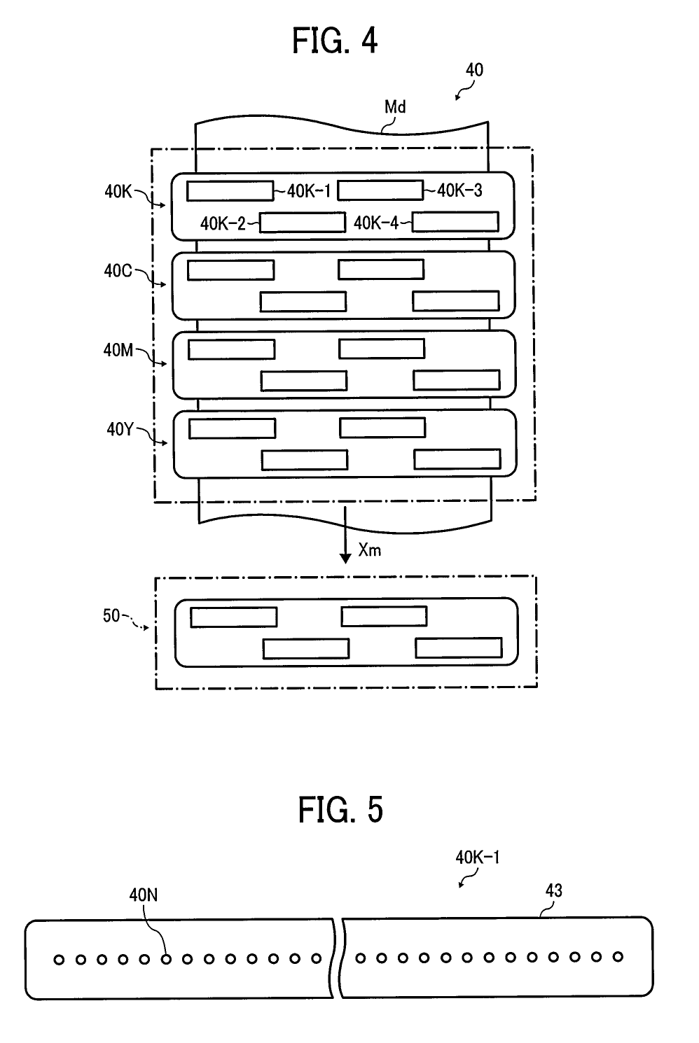

An example of an external shape of the image forming unit 40 will be described with reference to FIGS. 4 and 5. FIG. 4 is a schematic plan view showing an example of the image forming unit 40 and a post-processing unit 50 of the image forming apparatus 100 according to this embodiment. FIG. 5 is a schematic plan view showing an example of a head unit of an ejecting head for ejecting the black color ink of the image forming unit 40.

As shown in FIG. 4, the image forming unit can use the full-line heads. That is, the image forming unit 40 includes four ejecting heads 40K, 40C, 40M, and 40Y for different colors, black (K), cyan(C), magenta (M), and yellow (Y), in this order from upstream to down stream in a printing medium conveyance direction Xm.

The ejecting head 40K for ejecting the black (K) color ink includes four head units 40K-1, 40K-2, 40K-3, and 40K-4 which are arranged in a staggered manner in the direction perpendicular to the printing medium conveyance direction Xm. This enables the image forming apparatus 40 to form an image in the whole width of the image forming range (printing range) of the roll sheet Md (printing medium). A description of the configuration of the other ejecting heads 40C, 40M, and 40Y will be omitted as they are basically the same as the ejecting head 40K.

FIG. 5 is an enlarged plan view showing a head unit 40K-1 of the ejecting head 40K for ejecting the black color ink of the image forming unit 40.

As shown in FIG. 5, the head unit 40K-1 has a plurality of ejection openings 40N (nozzles, printing nozzles) on the nozzle face. The plural of eject openings 40N are arranged along a longitudinal direction of the head unit 40K-1, and form the nozzle array. Additionally, the head unit 40K-1 may have a plurality of nozzle arrays.

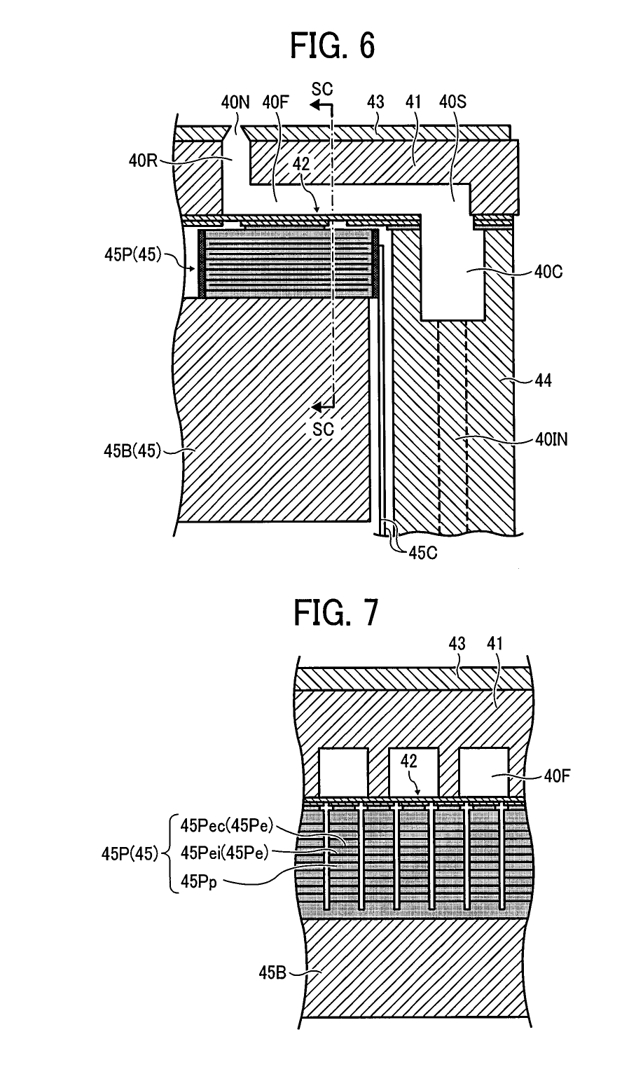

A cross-sectional view showing the ejecting head of the image forming unit 40 will be described with reference to FIGS. 6 and 7. FIG. 6 is a cross-sectional view showing an example of the ejecting head in the longitudinal direction of a liquid chamber 40F of the image forming unit 40. FIG. 7 is a cross-sectional view showing the ejecting head in the lateral direction (nozzle sequence directions) of the liquid chamber 40F of the image forming unit 40. FIG. 7 is a cross-sectional view when viewed along a line SC in FIG. 6.

As shown in FIG. 6, the ejecting head is configured with a nozzle communication channel 40R that is a flow channel communicating with a nozzle 40N for ejecting a recording liquid droplet (ink droplet) and a flow channel plate 41 which is formed adjacent, for example, by anisotropically etching a single crystal silicon substrate, a vibrating plate which is adjacent to the lower surface of the channel plate 41 and formed by means of, for example, nickel electroforming, and a nozzle plate 43 adjacent to the top surface of the flow channel plate 41, a liquid chamber 40F that is a pressure generating chamber, an ink supplying port 40S that is provided for supplying ink to the liquid chamber 40F through a fluid resistance part (supplying channel) and communicating with a common liquid chamber 40C, and the like.

Also, there are provided two lines of laminated-type piezoelectric elements 45P (that are not shown in the figures) as electromechanical elements which are pressure generating devices 45 (actuator devices) for pressurizing ink in the liquid chamber 40F by deforming the vibrating plate 42, and a base substrate 45B for mounting and fixing the piezoelectric elements 45P.

Additionally, supporting pillar parts are provided between the piezoelectric elements 45P.

The supporting pillar parts are parts that are formed together with the piezoelectric elements 45P by dividing and processing a piezoelectric member, but are simple supporting pillars since no driving voltage is applied thereon.

Also, FPC cables 45C on which a driving circuit (driving IC) is mounted and not shown in the figures are connected to the piezoelectric elements 45P.

Then, the peripheral portion of the vibrating plate 42 is connected to a frame member 44 and recesses provided for a perforation part for accommodating an actuator unit composed of the piezoelectric elements 45P, the base substrate 45B and the like and the common liquid chamber 40C and an ink supply port 40IN for supplying ink from the outside to the common liquid chamber 40C are formed on the frame member 44.

The frame member 44 is formed by means of an injection molding of, for example, a thermosetting resin such as epoxy-type resins or a poly(phenylene sulphite).

Herein, the flow channel plate 41 is provided by forming recesses and holes which are provided for the nozzle communication channel 40R and the liquid chamber 40F by, for example, anisotropically etching a single crystal silicon substrate with a crystallographic orientation (110) using an alkaline etching liquid such as an aqueous solution of potassium hydroxide (KOH). However, it is not limited to the single crystal silicon substrate and others such as a stainless substrate and photosensitive resins may also be used.

The vibrating plate 42 is formed from a metal plate of nickel and fabricated by, for example, an electroforming method (electrocasting method), and however, other metal plates, mounting members of metal and resin plates, and the like may also be used. The piezoelectric elements 45P and the supporting pillar parts are mounted to the vibrating plate 42 with a bonding material and the frame member 44 is further jointed with a bonding material.

The nozzle plate 43 includes a nozzle with a diameter of 10-30 μm which is formed so as to correspond to each liquid chamber 40F, and is mounted to the flow channel plate 41 with a bonding material. The nozzle plate 43 is such that a water-repellent layer is formed on the top surface of a desired layer on the surface of a nozzle forming member made of a metal member.

As shown in FIG. 7, the piezoelectric element 45P is a laminated-type piezoelectric element (herein, a PZT) provided by laminating piezoelectric materials 45Pp and internal electrodes 45Pe alternately.

A separate electrode 45Pei and a common electrode 45Pec are connected to each of the internal electrodes 45Pe which are alternately led to the different end faces of the piezoelectric element 45P.

Additionally, in this embodiment, there is provided a configuration such that ink in the liquid chamber 40F is pressurized by using a deformation of the piezoelectric element 45P in directions of d33 as directions of piezoelectricity, but there may also be provided a configuration such that ink in the pressurized liquid chamber 40F is pressurized by using a deformation of the piezoelectric element 45P in directions of d31 as directions of piezoelectricity.

Also, there may also be provided a configuration such that one line of piezoelectric elements 45P is provided on one substrate 45B.

In the thus configured liquid ejecting head, for example, when a voltage applied to the piezoelectric element 45P is lowered relative to a reference electric potential, the piezoelectric element 45P is contracted and the vibrating plate 42 is lowered so as to increase the volume of the liquid chamber 40F, whereby ink flows into the liquid chamber 40F. Subsequently, the voltage applied to the piezoelectric element 45P is increased so that the piezoelectric element 45P extends in the directions of lamination, and the vibrating plate 42 is deformed toward the direction of the nozzle 40N so as to decrease the volume of the liquid chamber 40F. Thereby, recording liquid (ink) in the liquid chamber 40F is pressurized so as to eject (jet) a drop of recording liquid (ink) from the nozzle 40N.

Then, when the voltage applied to the piezoelectric element 45P is set back to the reference electric potential, the vibrating plate 42 is restored to the initial state and the liquid chamber 40F expands so as to generate a negative pressure. Then, the inside of the liquid chamber 40F is filled with recording liquid (ink) from the common liquid chamber 40C.

Then, after the vibration of a meniscus surface at the nozzle 40N damps and is stabilized, transition to an operation for the next liquid drop ejection is made.

Additionally, the method for driving the head is not limited to the above example (pull-push-ejection) but pull-ejection or push-ejection may also be conducted depending on a method for providing a driving wave pattern.

Accordingly, the image forming apparatus 100 according to this embodiment can form a full-color image or a monochrome image in the whole width of the image forming range by the image forming unit 40 (the ejecting units 40K, 40C, 40M, and 40Y) during a single conveyance of the printing medium (roll sheet Md).

Additionally, the pressure generating devices 45 of the present invention are not limited to the above example (the piezoelectric element 45P). That is, the pressure generating device 45 may include, for example, a thermal actuator including an electrothermal converter element such as a heating resistor or the like applying a phase change in a liquid by film boiling, a shape memory alloy actuator applying metallic phase change by a temperature variation, and an electrostatic actuator applying electrostatic force generating a pressure for jetting a liquid droplet.

A configuration of the post-processing apparatus will now be described. The post-processing unit 50 is a unit for treating the printing medium on which an image was formed. In this embodiment, the post-processing unit 50 treats a surface of the roll sheet Md on which an image was formed by the image forming unit 40. The post-processing unit 50 treats the surface by a post-processing liquid.

As shown in FIG. 4, the post-processing unit 50 in this embodiment is arranged downstream from the image forming unit 40 in a printing medium conveyance direction Xm. The post-processing unit 50 includes post-processing head units 50H which are arranged in a staggered manner in the direction perpendicular to the printing medium conveyance direction. Furthermore, the post-processing unit 50 controls the amount of the post-processing liquid ejected (applied) by controlling a driving wave pattern inputted to the post-processing head units 50H. This enables the post-processing unit 50 to eject (apply) the post-processing liquid to the whole width of the image forming range (printing range) of the roll sheet Md (printing medium). A description of the configuration of post-processing head unit 50H will be omitted because it is basically the same as the configuration of the image forming unit 40 (FIGS. 4 to 7).

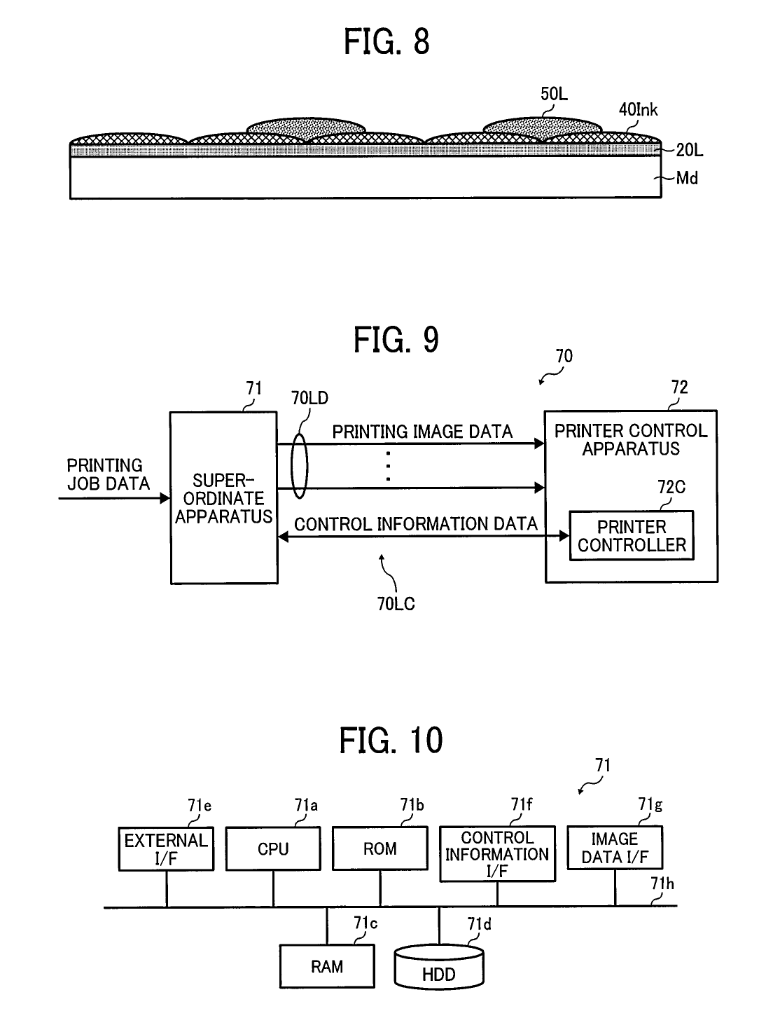

Post-processing is a process of ejecting (depositing) the post-processing liquid to the roll sheet Md (printing medium). The post-processing liquid is deposited in the shape of dots or stripes. This enables improvement of the abrasion resistance, glossiness, and preservation stability (the environment resistance, the water resistance, and the gas resistance, or the like) of the printing medium on which an image was formed. As shown in FIG. 8, when the post-processing unit starts the post-processing, the pre-processing liquid 20L has been applied to a surface of the roller sheet Md and ink 40Ink for forming an image is ejected on the surface. The post-processing unit 50 of the image forming apparatus 100 according to this embodiment performs the process of ejecting (depositing) the post-processing liquid 50L to the roll sheet Md on which an image was formed.

Furthermore, the post-processing unit 50 of the image forming apparatus 100 according to this embodiment can eject the post-processing liquid 50L to a smaller area than the surface area to which the pre-processing liquid 20L is applied. The post-processing unit 50 of the image forming apparatus 100 according to this embodiment can eject the post-processing liquid 50L to a smaller area than the surface area of the formed image.

That is, the post-processing liquid 50L is ejected (deposited) to a smaller area than the surface area of the pre-processing liquid 20L that is applied. In FIG. 8, the ink 40Ink is ejected to the entire area, and the post-processing liquid 50L is ejected (deposited) to a smaller area than the entire area.

Additionally, FIG. 8 shows that the post-processing liquid 50L is formed in the shape of dots. However, the post-processing liquid may be formed in the shape of stripes in the direction perpendicular to the cross section of the printing medium.

As shown in FIG. 8, this embodiment requires that the post-processing liquid 50L is ejected (deposited) to a smaller area than the surface area of the image that is formed. The post-processing liquid 50L may be ejected (deposited) to an area in which an image is not formed or may not be ejected (deposited) to the area on which an image is not formed.

When the printing medium which is formed in the shape in FIG. 8 is scraped against an object, a surface part of the layer of the post-processing liquid 50L is scraped against and onto the object. The post-processing liquid 50L prevents not only the ink 40Ink of the area on which the post-processing liquid 50L is ejected from peeling off, but also the ink 40Ink of the area on which the post-processing liquid 50L is not ejected from peeling off, because the layer of the post-processing liquid 50L has a certain thickness.

Accordingly, the image forming apparatus 100 according to an embodiment of present invention can eject (deposit) the post-processing liquid 50L by the post-processing unit 50 to the printing medium (roll sheet Md) on which an image was formed. This enables the image forming apparatus 100 according to this embodiment to prevent the image (ink) printed on the printing medium (roll sheet Md) from peeling off by being scraped against the object (e.g., an other printing medium), than when the post-processing liquid is not ejected (not deposited). That is, the image forming apparatus 100 can improve the abrasion resistance of the image to be formed on the printing medium, by using the post-processing unit 50.

Then, the image forming apparatus 100 can improve the quality of image to be formed on the printing medium, because the post-processing unit 50 can deposit (eject) the post-processing liquid 50L to the printing medium (roll sheet Md) on which an image is formed. That is, the image forming apparatus 100 can reduce problems such as bleeding of the image, a problem of image density, a problem of image tone, an ink strike-through, a problem of water resistance, or a problem of environment resistance, because the post-processing unit 50 can deposit (eject) the post-processing liquid 50L to the printing medium on which an image was formed.

The post-processing unit 50 of the image forming apparatus 100 according to this embodiment preferably ejects (deposits) to the area of the roll sheet Md on which an image was formed, as the post-processing method. Furthermore, The post-processing unit 50 preferably changes the amount of ejected post-processing liquid 50L and/or the method of ejecting, based on the type and/or the penetrability and/or the glossiness of the printing medium, and/or the resolution of an image to be printed, and/or the amount of pre-processing liquid applied by the pre-processing unit 20.

The post-processing unit 50 according to this embodiment can eject the needed amount of post-processing liquid, in a needed shape of dots, or in a needed shape of stripes, to the needed area.

Specifically, the post-processing unit 50 can eject to any area described as follows. The post processing unit 50 can eject to an area available for image forming. The post processing unit 50 can eject to an area on which an image was formed. The post processing unit 50 can eject to the area on which the ink droplets were ejected. The post-processing unit can also eject to a little (1 dot or 2 dots) larger area than the area of the roll sheet Md (printing medium) on which an image was formed. Furthermore, the post-processing unit can eject to an n percent area of the selected area (in the shape of dots or stripes).

The n percent may be from 5 percent to 50 percent. The n percent may be decided in an experiment or numerical calculations.

The post-processing unit 50 can decide the area for ejecting by using any decision method described as follows. The post-processing unit 50 can decide based on the coverage rate of printing. The post-processing unit 50 can decide based on the ejected amount of the post-processing liquid 50L. The post-processing unit 50 may also decide that first the post-processing unit calculates the amount of the post-processing liquid ejected or the coverage rate of printing based on inputted information (printing image data or the like), and then the post-processing unit 50 decides based on the amount of the post-processing liquid ejected or the coverage rate of print.

Accordingly, the post-processing unit 50 of the image forming apparatus according to an embodiment of present invention can eject (deposit) to an area related to the area on which an image was formed. This enables the image forming apparatus 100 according to this embodiment to shorten the time of post-processing and drying of the post-processing liquid. The image forming apparatus 100 according to this embodiment can reduce the amount of post-processing liquid than when the post-processing liquid is applied (ejected) to the entire surface of the printing medium. Furthermore, the image forming apparatus 100 according to this embodiment can reduce the cost of post-processing by reducing the amount of post-processing liquid than when the post-processing liquid is applied (ejected) to the entire surface of the printing medium.

Additionally, the post-processing method of the post-processing unit 50 is not particularly limited, and can be appropriately selected according to the type of post-processing liquid. The post-processing method of the post-processing unit 50 can be the pre-processing method of the pre-processing unit 20 or the ink ejecting method of the image processing unit 40. Furthermore, from the viewpoint of downsizing of the image forming apparatus and view point of the storage stability of the post-processing liquid, the post-processing method of the post-processing unit 50 is preferably the same method of the ink ejecting method of the image forming unit. When ejecting the post-processing liquid, the post-processing liquid preferably includes a water-soluble organic solvent. The water-soluble organic solvent may include a wetting agent. The wetting agent is added for the purpose of preventing clogging in a nozzle of an ejecting head which is caused by the drying of the recording liquid (ink) in the ink ejecting method of the image forming unit 40.

The amount of the post-processing liquid on the roll sheet Md after drying is preferably from 0.5 g/m² to 10 g/m². The amount of the post-processing liquid on the roll sheet Md after drying is more preferably from 2 g/m² to 10 g/m². Additionally, when the amount of the post-processing liquid on the roll sheet Md after drying is less than 0.5 g/m², the quality of the image (the abrasion resistance, glossiness, and preservation stability (the environment resistance, the water resistance, and the gas resistance, or the like)) may be reduced. When the amount of the post-processing liquid on the roll sheet Md after drying is more than 10 g/m², the drying characteristics of the layer of the post-processing liquid (a protective layer) may be reduced (it may take a long time to dry). Furthermore, when the amount of the post-processing liquid on the roll sheet Md after drying is more than 10 g/m², the quality of the image may be not improved any further, which may be economically unfavorable.

The post-processing unit 50 according to this embodiment can use a treating liquid which includes a material forming a clear protective layer on the roll sheet Md (printing medium) as the post-processing liquid. The treating liquid which includes a material forming a clear protective layer includes a water-based resin (a water-soluble resin or a water-dispersible resin), a water-soluble organic solvent (a wetting agent), a penetrating agent, a surfactant, water, and/or other components. The post-processing liquid may be an ultraviolet curing resin composition and/or a thermoplastic resin composition. Furthermore, for improving the glossiness and the fixability, the post-processing liquid is preferably a thermoplastic resin emulsion. This enables post-processing unit 50 to improve the glossiness of a surface of the roll sheet Md on which an image was formed, or to protect the surface of the roll sheet Md by the resin layer, based on the method of the ejecting (applying).

Any type of water-based resin may be used depending on the purpose. For example, the following water-based resins may be used: acrylic resin, styrene-acrylic resin, urethane resin, acylic silicone resin, a fluorine resin. The contained amount of the water based resin in the protective layer is preferably from 1% by mass to 50% by mass. Furthermore, when ejecting the post-processing liquid from the ejecting head, the contained amount of the water based resin in the protective layer is preferably from 1% by mass to 30% by mass. Additionally, in case that the contained amount of the water-based resin is greater than 50% by mass, viscosity of the post-processing liquid may be too high. When the contained amount of the water-based resin is less than 1% by mass, the energy of the post-processing unit for drying the water in the post-processing liquid may increase.

The average particle diameter of the water-based resin in the post-processing liquid relates to the viscosity of the post-processing liquid. In a case where there is a same composition, the average particle is smaller, and the viscosity is greater. Accordingly, for preventing too much viscosity of the post-processing liquid, the average particle diameter of the water based resin is preferably larger than 50 nm.

When the average particle diameter of the water-based resin in post-processing liquid is tens of nano meters, the average particle diameter may be larger than the nozzle diameter. The average particle diameter is preferably smaller than the nozzle diameter (a diameter of the eject opening 40N in FIG. 5). Even though the average particle diameter of the water based resin in the post-processing liquid is smaller than the diameter of the nozzle, when a large diameter particle is included, the ejecting ability may be deteriorated.

Accordingly, the average particle diameter of the water-based resin in post-processing liquid is preferably smaller than 200 nm, and more preferably smaller than 150 nm.

When using the water-soluble organic solvent (a wetting agent), the contained amount of the water-soluble organic solvent in post-processing liquid is not particularly limited. The contained amount of the water-soluble organic solvent may be from 10% by mass to 80% by mass. The contained amount of the water soluble organic solvent is preferably from 15% by mass to 60% by mass. The water-soluble organic solvent (a wetting agent) is for example, 1,3-butadiene, glycerin, or the like.

Additionally, when the contained amount of the water-soluble organic solvent is greater than 80% by mass, the drying characteristics of the post-processing liquid on the printing medium may be deteriorated. When the contained amount of the water-soluble organic solvent is less than 10% by mass, the components of the post-processing liquid may be changed by mixing with the pre-processing liquid.

Penetrating agent and surfactant is not limited. The penetrating agent is for example, 2-ethyl-1,3-hexanediol or the like. The surfactant is for example, polyethylene oxide end-capped with perfluoroalkyl or the like. As the penetrating agent and the surfactant used by the post-processing unit 50, penetrating agent and surfactant including the pre-processing liquid used by the pre-processing unit 20 or the ink using by the image forming unit 40 can be arbitrarily selected.

Additionally, the post-processing liquid may include other components. The post-processing liquid may include for example, wax, pH adjuster, antimicrobial agent, surface modifier, or antiforming agent.

The wax is for example, polyethylene wax or the like. The pH adjuster is for example, 2-amino-2-ethyl-1 3-propanediol or the like. The antimicrobial agent is for example, 1,2-benzothiazolyl-3-one or the like. The surface modifier is for example, polyether modified poly-dimethyl-siloxane (BYK-Chemie) or the like. The antiforming agent is for example, 2,4,7,9-Tetramethyl-4,7-decanediol or the like.

A configuration of the sheet discharging unit will now be discussed.

The sheet discharging unit 60 is a unit for discharging the printing medium on which an image was formed. As shown in FIG. 1, the sheet discharging unit 60 of this embodiment includes a sheet holder 61 and plural conveyance rollers 62. The sheet discharging unit 60 using the conveyance rollers rolls up the roll sheet Md in the roller of the sheet holder.

Additionally, when the pressure to the roll sheet Md is high when the roll sheet Md is rolled up in the roller of the sheet holder 62, a drying unit for drying the roll sheet Md may be disposed adjacent to the entrance of the sheet holder 62 for preventing transfer of an image to the reverse side of the sheet.

A configuration of the controlling unit will now be discussed. The controlling unit 70 is a unit for controlling the action of the image forming apparatus 100. The controlling unit of this embodiment instructs each component in the image forming apparatus 100, and controls the action of each component. The controlling unit 70 according to this embodiment will be described with reference to FIGS. 9 to 13.

Additionally, the image processing unit 100 may be a production printing system. A production printing system is a printing system that is able to print (form an image) to a large volume printing matter (document) in a short period of time, by efficiently controlling the job or the printing image data. Specifically, the image forming apparatus 100 (the controlling unit) according to this embodiment includes plural apparatuses. An apparatus controls the order of the printing job data, or transforms the printing job data to the raster image data (RIP process). The other apparatus performs printing based on the raster image data.

The image forming apparatus 100 (controlling unit 70) constructs a workflow system for managing from producing a printing job data to distributing the printing matter. That is, the image forming apparatus 100 (controlling unit 70) can more quickly process the workflow due to distributing the process among the plural apparatuses.

As shown in FIG. 9, the controlling unit 70 of the image forming apparatus 100 according to this embodiment includes a superordinate apparatus 71 (DFE, digital front end, RIP, raster image processor or the like) and a printer control apparatus 72. The superordinate apparatus 71 performs production of the raster image data (RIP process), for example. The printer control apparatus 72 is included in a printing apparatus for printing. The superordinate apparatus 71 and the printer control apparatus 72 are connected via a plurality of data lines 70LD and a plurality of control lines 70LC.

The superordinate apparatus 71 and the printer control apparatus 72 of the controlling unit 70 according to this embodiment will be explained in the following order.

The superordinate apparatus will now be discussed. The superordinate apparatus 71 is the apparatus for producing the raster image data (RIP process) based on the printing job data (printing data, job data or the like) which is received from the host apparatus. That is, the superordinate apparatus 71 produces the raster image data (hereinafter referred to as printing image data) corresponding to the ink colors, based on the printing data. The printing image data includes the data related to ejecting the post-processing liquid by the post-processing unit 50 (hereinafter referred to as post-processing liquid image data).

The superordinate apparatus 71 produces the data for controlling the printing action (hereinafter referred to as control information data), based on the printing job data or the information of the host apparatus. The control information data includes the type of the printing, the form of the printing, the information of the feeding and discharging of the sheet, the order of a surface of the printing, the size of the sheet for printing, the size of the data of the printing image data, the resolution, the type of the sheet, the tonal range, the information of the color, the number of the page or the like. The control information data includes the data of the ejecting of the post-processing liquid which is ejected by the post-processing unit 50 (hereinafter referred to as post-processing control data).

As shown in FIG. 10, the superordinate apparatus 71 of this embodiment includes the CPU (Central Processing Unit) 71a, ROM (Read Only Memory) 71b, RAM (Random Access Memory) 71c, and HDD (Hard Disk Drive) 71d. The superordinate apparatus 71 includes an external interface 71e, a control information interface 71f, an image data interface 71g. Moreover, the superordinate apparatus 71 includes a bus 71h which connects to the CPU 71a, etc. That is, the CPU 71a etc. in the superordinate apparatus 71 can communicate via the bus 71h.

The CPU 71a controls the entire superordinate apparatus 71. The CPU 71a controls the action of the superordinate apparatus 71 by using the control program in the ROM 71b and/or HDD 71d.

The ROM 71b, the RAM 71c, and the HDD 71d store the data or the like. The ROM 71b and/or the HDD 71d previously stores the control program for controlling the CPU 71a. The RAM 71c uses as the work memory of the CPU 71a.

The external interface 71e controls the external communication of the image forming apparatus 100. The external interface 71e can control communication corresponding to TCP/IP (Transmission Control Protocol/Internet Protocol).

The control information interface 71f controls the communication of the control information data. The control information interface 71f can control the communication corresponding to the PCI Express (Peripheral Component Interconnect Buss Express).

The imaged data interface 71g controls the communication of the printing image data. The image data interface 71g can control the communication corresponding to the PCI Express. The image data interface 71g includes plurality of channels corresponding to each color of the printing image data.

The superordinate apparatus 71 of the controlling unit 70 according to this embodiment receives the printing job data from the host apparatus by the external interface 71e, then the superordinate apparatus 71 stores the printing job data to the HDD 71d using the CPU 71a. The superordinate apparatus 71 reads the printing job data from the HDD 71d using the CPU 71a. Furthermore, the superordinate apparatus 71 produces the plurality of raster image data of each color (Yellow (Y), Cyan (C), Magenta (M), and Black (B)), then the superordinate apparatus 71 stores each color of the raster image data to the RAM 71c. At this time, the superordinate apparatus 71 (controlling unit 70) can produce each color of raster image data by rendering the PDL (Page Description Language) as the RIP processing, then the superordinate apparatus 71 stores to the RAM 71c.

Next, the superordinate apparatus 71 compresses and encodes each color of raster image data then the superordinate apparatus 71 stores the

HDD 71d.

When the print controlling apparatus starts the print action, the superordinate apparatus 71 (CPU 71a) reads each raster image data from the HDD 71d, then the superordinate apparatus 71 decodes each of the raster image data and stores to the RAM 71c each of the raster image data which is decoded. Next the superordinate apparatus 71 reads each color of raster image data from the RAM 71c, then the superordinate apparatus 71 outputs each color of raster image data to the printer control apparatus 72 via each channel of the image data interface 71g. The superordinate apparatus 71 can output the printing image data to the printer control apparatus 72 via a plurality of data lines 70LD (70LD-Y, 70LD-C, 70LD-M and 70LD-K) in FIG. 9 corresponding to the colors.

The superordinate apparatus 71 receives and sends the control information data to the printer control apparatus 72 via the control information interface 71f (control lines 70LC) corresponding to the progression of the printing action.

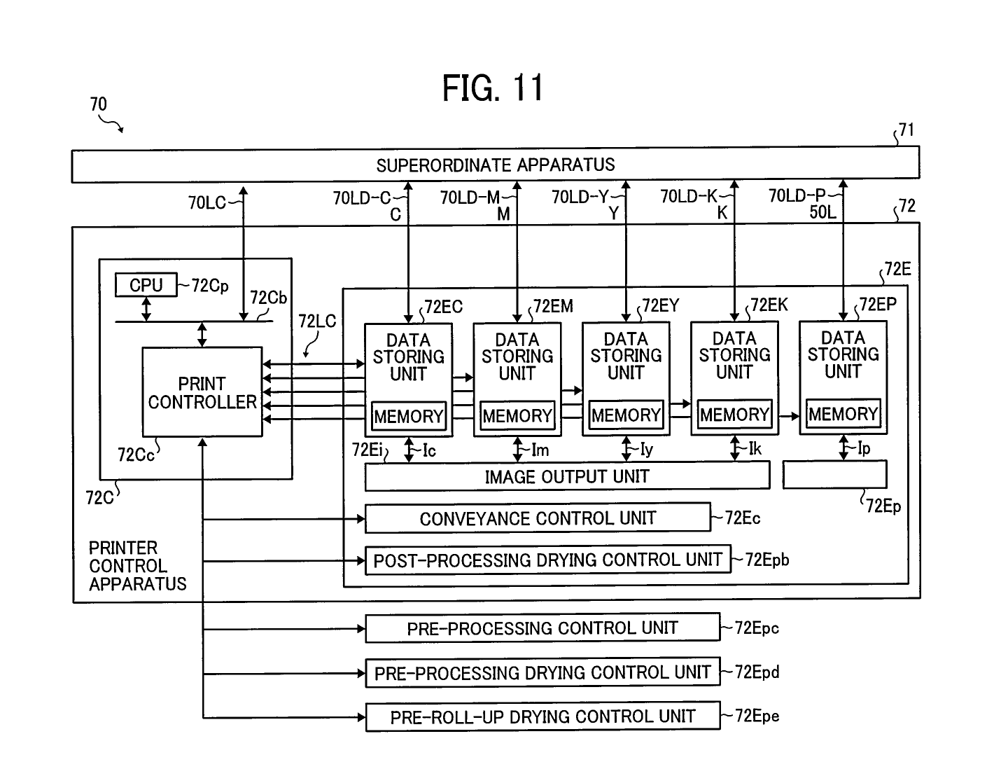

Furthermore, when the printer control apparatus starts the post processing, the superordinate apparatus 71 according to this embodiment reads the encoded post-processing liquid image data from the HDD by the CPU 71a. The superordinate apparatus 71 outputs to the printer control apparatus 72 via the data line 70LD-P (FIG. 11)

The printer control apparatus will now be discussed. The printer control apparatus 72 of the controlling unit 70 according an embodiment of the present invention is the apparatus for controlling the action of forming an image on the printing medium based on the printing image data and the control information data. The printer control apparatus 72 of this embodiment includes the printer controller 72C and the printer engine 72E.

The printer controller 72C controls the action of the printer engine 72E. The printer controller 72C receives and sends the control information data etc. to the superordinate apparatus 71 via the control line 70LC. The printer controller 72C receives and sends the control information data etc. to the printer engine 72E via the control line 72LC. This enables the printer controller 72C to write the various printing conditions which are included in the control information data to a register of a print control unit 72Cc, and store the printing condition. The printer controller 72C can control the printer engine 72E based on the control information data, and print based on the printing job data (control information data).

As shown in FIG. 11, the printer controller 72C of this embodiment includes a CPU 72Cp and the print control unit 72Cc. The CPU 72Cp and the print control unit 72Cc are connected via a bus 72Cp in the printer controller 72C. The bus 72Cb is connected to the control lines 70LC via communication interface.

The CPU 72Cp controls the actions of the entire printer control apparatus 72 using a control program in a ROM. The print control unit 72Cc receives and sends the command or the status information to the printer engine 72E based on the control information data which is received from the superordinate apparatus 71. This enables print control unit 72Cc to control the action of the printer engine 72E.

The printer engine 72E controls the action of forming an image on the printing medium based on the printing image data which is received from the superordinate apparatus 71 and the control information data which is received from the printer controller 72C. The printer engine 72E controls the action of the post-processing based on the printing image data (post-processing liquid image data) which is received from the superordinate apparatus 71 and the control information data (post-processing control data) which is received from the printer controller 72C.

As shown in FIG. 11, the printer engine 72E is connected to the plurality of data lines 70LD (70LD-Y, 70LD-C, 70LD-M, 70LD-K, and 70LP-P). The printer engine 72E receives the printing image data from the superordinate apparatus 71 via the plurality of the data lines (70LD-C) or the like. This enables the printer engine 72E to control the action of the forming of image data and the performing of the post-processing based on the printing image data which is received.

The printer engine 72E of this embodiment includes a plurality of data storing units 72EC, 72EM, 72EY, 72EK, and 72EP. The printer engine 72E includes an image output unit 72Ei which is received from the data storing unit 72C etc., and a conveyance control unit 72Ec which controls the conveying of the printing medium. Furthermore, the printer engine 72E of this embodiment includes a post-processing liquid output unit 72Ep which receives the post-processing liquid image data from the data storing unit 72EP, and a post-processing drying control unit 72Epb which controls the drying unit 30 (FIG. 1).

Additionally, the printer engine 72E may include a pre-processing control unit 72Epc, a pre-processing drying control unit 72Epd, and pre-roll-up drying control unit 72Epe.

The configuration of the data storing unit 72EC will be explained with reference to FIG. 11. Additionally, the configuration of the other data storing units 72EM, 72EY, 72EK, and 72EP will be omitted because they basically have the same configuration as the data storing unit 72EC.

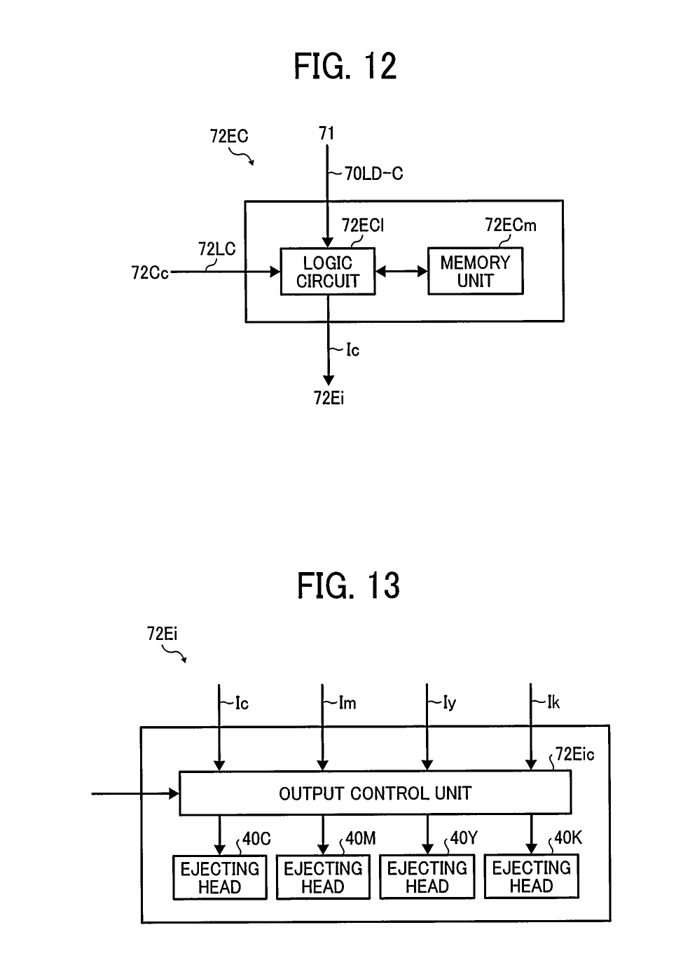

As shown in FIG. 12, the data storing unit 72EC includes a logic circuit 72EC1 and a memory unit 72ECm. The data storing unit 72EC (the logic circuit 72ECI) is connected to the superordinate apparatus 71 via the data line 70LD-C. The data storing unit 72EC (the logic circuit 72ECI) is connected to the printer controller 72C (print control unit 72Cc) via the control line 72LC.

The logic circuit 72EC1 stores the printing image data to the memory unit 72ECm which is outputted from the superordinate apparatus 71, based on the control signal which is outputted from the printer controller 72C (print control unit 72Cc). Based on the control signal which is outputted from the printer controller (print control unit 72Cc), the logic circuit 72EC1 reads the printing image data Ic (FIG. 8) from the memory unit 72ECm corresponding to cyan (C), and outputs to the image output unit 72Ei. Additionally, the logic circuit 72EC1 (data storing unit 72EP) outputs the post-processing liquid image data Ip (FIG. 8) to the post-processing liquid output unit 72Ep.

The memory unit 72ECm can have a capacity which is able to store the image data of three pages or more. The three pages of printing image data include printing image data corresponding to a page which is received from the superordinate apparatus 71, and printing image data corresponding to a page which is sent to the image output unit 72Ei, and printing image data corresponding to a next sending page.

Additionally, the data storing unit 72EC may use a hardware logical circuit which is configured to include a combination of a plurality of logical circuits. This enables the data string unit 72EC to perform the process at higher speed. The data storing unit 72EC may decide whether to perform the process by logical determination against the control signal of the bit sequence, for example.

The configuration of the image output unit 72Ei will be described with reference to FIG. 13. Additionally, the configuration of the post-processing liquid output unit 72Ep will be omitted because it is basically the same as the configuration of the image output unit 72Ei.

As shown in FIG. 13, the image output unit 72Ei includes the output control unit 72Eic. The output control unit 72Eic outputs each of the printing image data to each ejecting head 40C, 40M, 40Y, and 40K (FIG. 4) corresponding to the color of the printing image data. This enables the output control unit 72Eic to control the action of the ejecting head 40C etc., based on the printing image data.

Specifically, the output control unit 72Eic individually controls the plurality of the ejecting heads 40C, 40M, 40Y, and 40K. The output control unit 72Eic may simultaneously control the plurality of the ejecting heads 40C, 40M, 40Y, and 40K, based on the printing image data (Ic, Im, Iy, and Ik in FIG. 13). Furthermore, the output control unit 72Eic may control the ejecting head 40C etc. based on the control signal which is inputted from a control apparatus. The output control unit 72Eic may control the ejecting head 40C etc. based on the operation input of the user.

Accordingly, the printer control apparatus 72 inputs to the plurality of ejecting heads 40C etc. the printing image data which is outputted from the superordinateapparatus7l, by using the data storing unit 72EC and the output control unit 72Eic. At this time, the printer control apparatus 72 can individually control each color of printing image data. The printer control apparatus 72 can change the configuration of the printer engine 72E corresponding to the number of colors of the printing image data (C, M, Y, and K or K only) or the number of the ejecting heads. That is, the printer control apparatus 72 in the image forming apparatus 100 according to this embodiment can reduce the cost and downsize the apparatus by mounting only the data storing unit 72EC needed and the ejecting head 40C needed.

For example, when forming the full-color image by the C, M, Y, and K, the printer control apparatus 72 in the image forming apparatus 100 according to this embodiment can have all of the data storing units 72EC, etc. This enables the printer control apparatus 72 in the image forming apparatus 100 to connect to the ejecting heads 40C, etc., each output from the data storing units 72EC etc., by the output control unit 72Eic.

For example, when forming the image by K only, the printer control apparatus 72 in the image forming apparatus 100 can have one data storing unit 72EK and one ejecting head 40K when prioritizing cost. This enables the printer control apparatus 72 in the image forming apparatus 100 to connect to the ejecting head 40K to the output from the data storing unit 72EK by the output control unit 72Eic.

Furthermore, for example, when forming the image by K only, the printer control apparatus 72 in the image forming apparatus 100 can have one data storing unit 72EK and four ejecting heads when prioritizing the speed of printing.

This enables the printer control apparatus 72 in the image forming apparatus 100 to connect the output from the data storing unit 72EK to each of the four ejecting heads by the output control unit 72Eic.

In this case, the printer control apparatus in the image forming apparatus 100 can form an image at a speed four times the speed of using one ejecting head, because of forming one color (K) by four ejecting heads.

Having generally described this invention, further understanding can be obtained by reference to certain specific examples which are provided herein for the purpose of illustration only and are not intended to be limiting.

A First Example of an Image Forming Apparatus:

The present invention will be described with reference to image forming apparatus 100E in the first example.

The configuration of the image forming apparatus 100E are shown in FIGS. 1 to 7. As shown in FIGS. 1 to 7, the configuration of the image forming apparatus 100E of this example will be omitted because it is basically the same as the configuration of the image forming apparatus 100 in the foregoing embodiment.

The configuration of a controlling unit 70 of the image forming apparatus 100E are shown in FIGS. 9 to 13. As shown in FIGS. 9 to 13, the configuration of the controlling unit of the image forming apparatus 100E of this example will be omitted because it is basically the same as the configuration of the controlling unit 70 of the image forming apparatus 100 in the foregoing embodiment. Therefore, the same description is not repeated.

The controlling unit 70 of this example determines the type of the printing medium.

The controlling unit 70 of this example determines the type of the printing medium based on the operation inputted to the image forming apparatus 100E by the user.

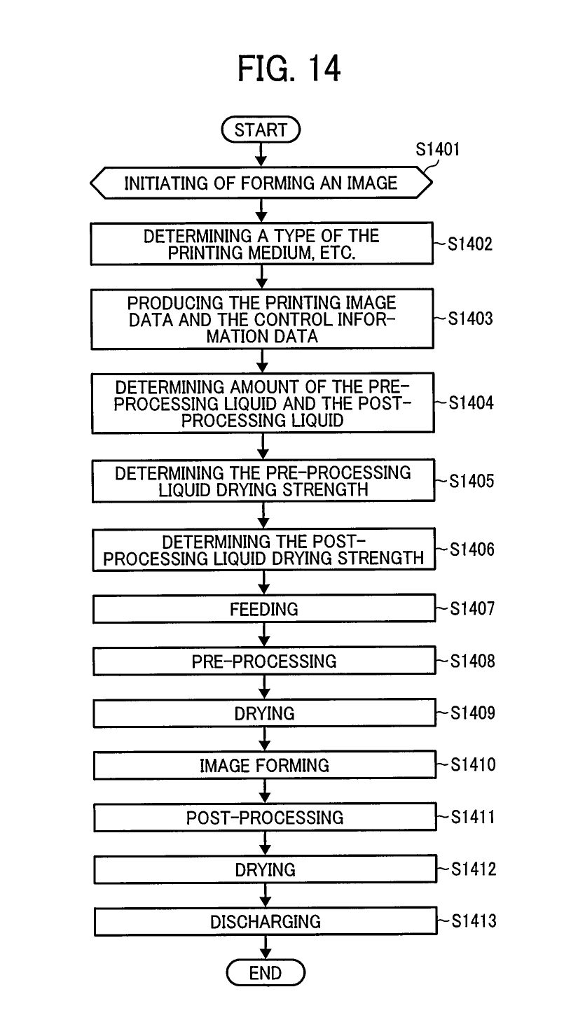

The operation of forming an image by the image forming apparatus 100E according to this example will be described with reference to FIG. 14.

As shown in FIG. 14, the image forming apparatus 100E according to this example, in step S1401, initiates forming of an image, based on printing job data which is inputted externally from the image forming apparatus 100E. The image forming apparatus 100E stores the printing job data which is inputted to the HDD 71d of the superordinate apparatus 71.

Then, in step S1402, the image forming apparatus 100E determines a type of the printing medium by controlling unit 70, and stores (sets) the determined type of printing medium to the HDD 71d of the superordinate apparatus 71.

At this time, the controlling unit 70 may store further information of the printing medium (a physical property value of the printing medium (a material, a thickness, a basis weight of the paper, or the like). The controlling unit 70 may store the type of the printing medium related to the pre-stored type of the printing medium in the HDD 71d of the superordinate apparatus 71. This enables the controlling unit 70 to read the type of the printing medium in the latter, by using the related type. Additionally, the image forming apparatus 100E can pre-store the type of the printing medium to the HDD 71d of the superordinate apparatus 71 based on the inputted operation of the user.

Then, in step S1403, the image forming apparatus 100E produces the printing image data and the control information data or the like by the superordinate apparatus 71 of the controlling unit 70. Specifically, the superordinate apparatus 71 of the controlling unit 70 produces the printing job data and the control information data based on at least the resolution of the image in the printing job data which is stored in the HDD 71d or the like.

Then, in step S1404, the image forming apparatus 100E calculates the amount of the pre-processing liquid (the amount of applied liquid in this example), and the post-processing liquid (these amount of ejected liquid in this example) by the controlling unit 70.

Specifically, the controlling unit 70 calculates the amount of applied pre-processing liquid 20L by the pre-processing unit 20 and the amount of ejected post-processing liquid 50L by the post-processing unit 50, based on at least the resolution of the image. When the resolution of the forming image is high, the controlling unit 70 can reduce the amount of applied pre-processing liquid 20L. Furthermore, when the resolution of the forming image is low, the controlling unit 70 can raise the amount of applied pre-processing liquid 20L.

When the low resolution image is formed, the diameter of a ink dot is large compared to when a high resolution image is formed, and ink dots are difficult to dry because an ink dot has a large volume relative to surface area. Because the printing speed is high compared to when a high resolution image is formed and ink dots are difficult to dry and penetrate, bleeding of the image can easily happen. Accordingly, the controlling unit 70 reduces the amount of applied pre-processing liquid 20L when a high resolution image is formed, and raises the amount of applied pre-processing liquid 20L when a low resolution image is formed.

Furthermore, when the resolution of the forming image is high (the diameter of the ink dot is small), the controlling unit 70 can reduce the amount of ejected post-processing liquid 50L. When the resolution of the forming image is low (the diameter of the ink dot is large), the controlling unit 70 can raise the amount of ejected pre-processing liquid 50L.

That is, the controlling unit 70 can calculate the amount of applied pre-processing liquid 20L based on the resolution of the forming image, and can calculate the amount of ejected post-processing liquid 50L based on the resolution of the forming image. The calculating of post-processing liquid 50L is based on at least the resolution of the forming image and includes calculating the amount of ejected post-processing liquid 50L based on the amount of applied pre-processing liquid which is calculated based on the resolution of the forming image. This enables the image forming apparatus 100E to improve the abrasion resistance by raising the amount of ejected post-processing liquid 50L, when the resolution of the formed image is low and the abrasion resistance of the formed image is reduced.

Additionally, the controlling unit 70 can set the amount of applied pre-processing liquid 20L to 1.5 g/m² or more, when raising the amount of applied pre-processing liquid 20L. The controlling unit 70 can set the amount of applied post-processing liquid 50L to 1.2 g/m² or more, when raising the amount of applied post-processing liquid 50L. Alternatively, the controlling unit 70 can set the amount of applied pre-processing liquid 20L to less than 1.5 g/m², when reducing the amount of applied pre-processing liquid 20L. The controlling unit 70 can set the amount of applied post-processing liquid 50L to less than 1.2 g/m², when reducing the amount of applied post-processing liquid 50L. The controlling unit 70 doesn't need to apply and eject, when reducing the amount of applied pre-processing 20L and the amount of ejected post-processing liquid 50L. Furthermore, the controlling unit 70 may change the amount of applied pre-processing liquid 20L and the amount of ejected post-processing liquid 50L, corresponding to the physical property value of the printing medium or the like.

The image forming apparatus 100E performs step S1405 after calculating the amount of the pre-processing liquid 20L and the post-processing liquid 50L. Additionally, the image forming apparatus 100E may receive the amount of the pre-processing liquid 20L and the post-processing 50L liquid related to the type of the printing medium to the operation input of the user by using the UI (User Interface) or the like.

In step S1405, the image forming apparatus 100E determines the drying strength (pre-processing liquid drying strength) of the pre-processing liquid drying unit 31 (FIG. 1) based on at least the resolution of the forming image. The image forming apparatus 100E may determine the drying strength (pre-processing liquid drying strength) using further amounts of applied pre-processing liquid 20L.

Then, in step S1406, the image forming apparatus 100E determines the drying strength (post-processing liquid drying strength) of the post-processing liquid drying unit 32 (FIG. 1) based on at least the resolution of the forming image. The image forming apparatus 100E may determine the drying strength (post-processing liquid drying strength) using further amounts of ejected post-processing liquid 50L.

Then, in step S1407, the image forming apparatus 100E feeds the printing medium to the pre-processing unit 20 by using the sheet feeding unit 10 (FIG. 1). Additionally, the image forming apparatus 100E may initiate step S1407 soon after the initiation of step S1401. The image forming apparatus 100E performs step S1408 after initiating the feeding.

In step S1408, the image forming apparatus 100E performs the pre-processing by using the pre-processing unit 20 (FIG. 1). Specifically, the pre-processing unit 20 controls the nip pressure based on the amount of applied pre-processing liquid 20L which is calculated in step S1404 by using the pressure controller 25, and controls (changes) the amount of applied pre-processing liquid 20L (the thickness of the liquid film, etc.). Additionally, the pre-processing unit 20 may control the amount of applied pre-processing liquid 20L by changing the rotation speed of the applying roller 23 (FIG. 2). This enables the image forming apparatus 100E to reduce the bleeding of the formed image by controlling the amount of applied pre-processing liquid 20L.

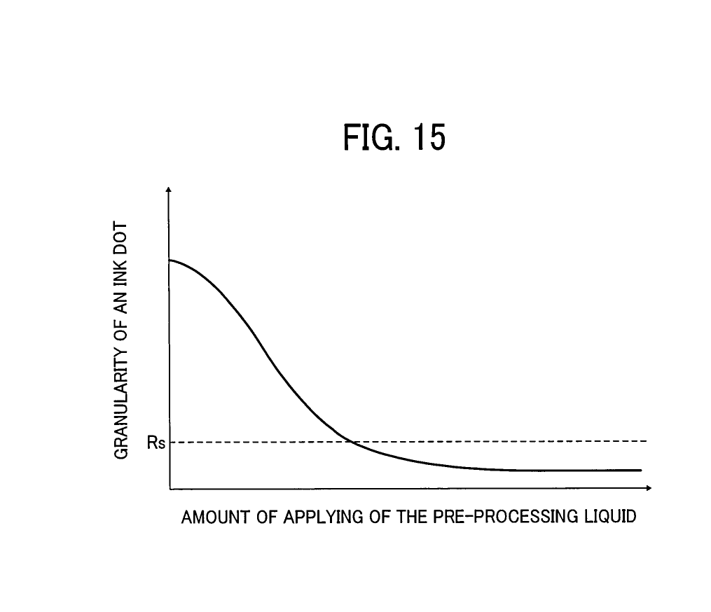

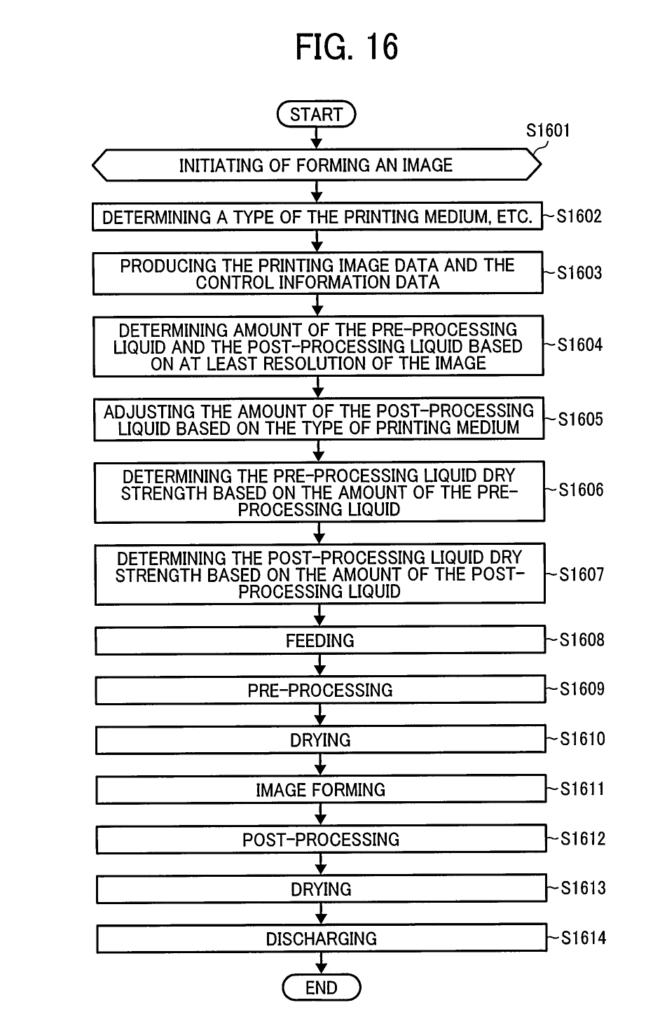

As shown in FIG. 15, the image forming apparatus 100E can make the granularity of an ink dot to be small, by raising the amount of applied pre-processing liquid 20L. That is, in the image forming apparatus 100E, the granularity of ink dots can be less than a predetermined granularity Rs, by raising the amount of applied pre-processing liquid 20L. The predetermined granularity Rs can be the granularity in which it is difficult to bleed the ink on the printing medium. The predetermined granularity Rs can be determined in an experiment or numerical calculations. Then, the image forming apparatus 100E feeds the printing medium to the drying unit 30 (the pre-processing liquid drying unit 31 in FIG. 1).

In step S1409, the image forming apparatus 100E dries the printing medium by using the pre-processing liquid drying unit 31 (FIG.1). The pre-processing liquid drying unit 31 dries the printing medium based on the pre-processing liquid drying strength which was determined in step S1405.

Then, the image forming apparatus 100E feeds the printing medium to the image forming unit 40 (FIGS. 1, 4,5).

In step S1410, as an image forming step, the image forming apparatus 100E forms an image on a surface of the printing medium by using the image forming unit 40, based on the printing image data which was produced (in step S1403). The image forming unit 40 may form an image by further using the resolution of the forming image and the type of the printing medium. The image forming unit 40 can control the action of the image forming by controlling the voltage applied to the piezoelectric element 45P (the pressure generating device 45 in FIGS. 6,7).

Then, the image forming apparatus 100E feeds the printing medium to the post-processing unit 50 (FIG. 1).

In step S1411, as a post-processing step, image forming apparatus 100E treats the printing medium by using the post-processing unit 50.

Specifically, the post-processing unit 50 ejects (deposits) the post-processing liquid 50L to a specific area in the area of forming an image of the printing medium, based on the post-processing liquid image data (in step S1403) and the amount of ejected post-processing liquid which was calculated (in step S1404). The post-processing unit 50 can control the amount of ejected post-processing liquid 50L on the printing medium by using the post-processing liquid output unit 72Ep of the controlling unit 70, based on the post-processing liquid image data.

Then, the image forming apparatus 100E feeds the printing medium to the drying unit 30 (the post-processing liquid drying unit 32 in FIG. 1).

In step S1412, the image forming apparatus 100E dries the printing medium by using the post-processing liquid drying unit 32 (heat roller). The post-processing liquid drying unit 32 dries the printing medium based on the post-processing liquid drying strength which was determined in step S1406.

Then, in step S1413, the image forming apparatus 100E discharges the printing medium by using the sheet discharging unit 60 (FIG. 1).

Then, in the END step, the image forming apparatus 100E completes the image forming operation.

Accordingly, the image forming apparatus 100E according to this example can obtain the same effect as the image forming apparatus 100 in the embodiment.

A Second Example of an Image Forming Apparatus:

The present invention will be described with reference to image forming apparatus 200E in the second example.

The configuration of the image forming apparatus 200E is shown in FIGS. 1 to 7. As shown in FIGS. 1 to 7, the configuration of the image forming apparatus 200E of this example will be omitted because it is basically the same as the configuration of the image forming apparatus 100 in the foregoing embodiment and the image forming apparatus 100E in the first example.

The configuration of a controlling unit 70 of the image forming apparatus 200E is shown in FIGS. 9 to 13. As shown in FIGS. 9 to 13, the configuration of the controlling unit of the image forming apparatus 200E of this example will be omitted because it is basically the same as the configuration of the controlling unit 70 of the image forming apparatus 100 in the foregoing embodiment and the image forming apparatus 100E in the first example. Therefore, the same description is not repeated.

The flowchart of the first example (FIG. 14) does not describe a step of adjusting (re-calculating) the amount of the post-processing liquid (the amount ejected). The controlling unit of this example includes the step of adjusting (re-calculating) of the amount of the post-processing liquid (the amount ejected), based on at least information of the printing medium.

The operation of forming an image by the image forming apparatus 200E according to this example will be described with reference to FIG. 15.

As shown in FIG. 13, the image forming apparatus 200E performs a step S1601 to a step S1604 similarly to the image forming apparatus 100E of the first example (step S1401 to step S1404). In step S1604, the image forming apparatus 200E calculates the amount of the pre-processing liquid and the post-processing liquid by using the controlling unit 70, based on at least the resolution of the image.

Then, in step S1605, the image forming apparatus 200E adjusts (re-calculates) the amount of the post-processing liquid 50L (the amount ejected) by using the controlling unit 70 based on information on the type of the printing medium.

Then, in step S1606, the image forming apparatus 200E determines the pre-processing liquid drying strength by the controlling unit 70. In this example, the controlling unit 70 determines the pre-processing liquid drying strength, based on the amount of the pre-processing liquid which was calculated in step S1604.

Then, in step S1607, the image forming apparatus 200E determines the post-processing liquid drying strength by the controlling unit 70. In this example, the controlling unit 70 determines the post-processing liquid drying strength, based on the amount of the post-processing liquid which was calculated in step S1604.

Next, the image forming apparatus 200E performs a step S1608 to a step S1614 similar to the image forming apparatus 100E of the first example (step S1407 to step S1413). Then, in the END step, the image forming apparatus 200E completes the image forming operation.

Additionally, the image forming apparatus 200E may also adjust (re-calculate) the amount of pre-processing liquid applied based on information on the type of the printing medium.

Accordingly, the image forming apparatus 200E according to the second example can obtain the same effect as the image forming apparatus 100 in the embodiment and the image forming apparatus 100E in the first example.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings. It is therefore intended that the scope of the invention be limited not by this detailed description, but rather by the claims appended hereto.

What is claimed is:

1. An image forming apparatus comprising:
an ink jet head configured to eject droplets on a image forming apparatus, and to form an image on a surface of a printing medium;
a pre-processor configured to apply a pre-processing liquid to the surface of the printing medium before forming of the image by the ink jet head; and
a post-processor configured to apply a post-processing liquid, which is different from the pre-processing liquid to the surface of the printing medium after the forming of the image by the ink jet head,
wherein the pre-processor applies an amount of the pre-processing liquid which is determined based on resolution of the formed image on the printing medium, the post-processor applies on amount of the post-processing liquid which is determined based on the resolution of the formed image on the printing medium.

2. The image forming apparatus as in claim 1,
wherein the post-processor applies the post-processing liquid to a smaller area than a surface area of the formed image.

3. The image forming apparatus as in claim 1,
wherein the post-processor applies the post-processing liquid to a smaller area than a surface area on which the pre-processing liquid is applied.

4. The image forming apparatus as in claim 1,
wherein the amount of applied post-processing liquid is further determined based on a type of the printing medium.

5. The image forming apparatus as in claim 1,
wherein the amount of applied post-processing liquid is further determined based on glossiness of the printing medium.

6. An image forming method, comprising:
applying a pre-processing liquid to a surface of a printing medium;
forming an image on the surface of the printing medium on which the pre-processing liquid is applied; and
applying a post-processing liquid, which is different from the pre-processing liquid, to the surface of the printing medium on which the image is formed,
wherein the applied amount of pre-processing liquid is determined based on resolution of the formed image on the printing medium, the applied amount of post-processing liquid is determined based on the resolution of the formed image on the printing medium.

7. The image forming method as in claim 6,
wherein the post-processing liquid is applied in a shape of dots or stripes to the surface of the printing medium on which the image is formed or the pre-processing liquid is applied.

8. The image forming method as in claim 6,
wherein the amount of applied post-processing liquid is reduced when the resolution of the image is high, and the amount of applied post-processing liquid is raised when the resolution of the image is low.

9. The image forming method as in claim 6,
wherein the amount of applied post-processing liquid is reduced when the amount of applied pre-processing liquid is reduced, and the amount of applied post-processing liquid is raised when the amount of applied pre-processing liquid is raised.

10. The image forming method as in claim 6,
wherein the amount of applied post-processing liquid is raised when the glossiness of the formed image is raised.
